(19) United States
(12) Patent Application Publication
(10) Pub. No.: US 2026/0195417 A1
(43) Pub. Date: Jul. 9, 2026

(54) Quav Code Pattern Recognition and Interpretation System

(71) Applicant: Wendy Renee' Carlton, Lacombe, LA (US)

(72) Inventor: Wendy Renee' Carlton, Lacombe, LA (US)

(73) Assignee: I Control Me LLC, Lacombe, LA (US)

(21) Appl. No.: 19/238,555

(22) Filed: Jun. 16, 2025

Related U.S. Application Data
(63) Continuation-in-part of application No. 19/010,135, filed on Jan. 5, 2025.

(51) Int. Cl. G06F 18/26

(52) U.S. Cl. CPC G06F 18/26

(57) ABSTRACT

The Quav Code system detects and interprets acronymical, numerical, coding, and geographical patterns across diverse data inputs. The system incorporates geographical data (e.g., GIS datasets, satellite imagery), non-geographical data (e.g., public records, numerical sequences), proprietary data (e.g., the Quav Code Key, Copyrighted Observational Notes, Transcripts, Quav Code Mathematical Date Key, Quav Code Mathematical Decodation Formula), all coding techniques (e.g., HTML, CSS, Python, UPC labeling, GTIN coding language), and cryptographic algorithms. These inputs are analyzed by a decoding framework to identify correlations and patterns. An interpretation engine contextualizes these patterns into actionable insights, providing outputs for creative works, advocacy, coding analysis, and analytical purposes. The system also includes a bot to assist in dataset curation and interpretation. The Quav Code system's hybrid approach enables pattern detection with or without geographical data, offering a global framework for advanced pattern recognition and analysis.

This application is a Continuation-in-Part (CIP) of U.S. Non-Provisional application Ser. No. 19/010,135, filed on Jan. 5, 2025, the contents of which are incorporated herein by reference in their entirety.

### SPECIFICATION (FINALIZED)

1. The Quav Code system addresses the growing need for tools that detect and interpret hidden patterns in communication, geographical carvings, and coding techniques. Current systems lack the ability to integrate diverse data sources, coding formats, or provide contextualized interpretations. This invention overcomes these limitations by combining geographical, non-geographical, proprietary data inputs, all coding techniques, UPC labeling, and GTIN coding language with an advanced decoding framework and interpretation engine.

### 2. Inputs

a. Geographical Data: Satellite Imagery, GIS Data Sets, Aerial Photography, Geographical Maps, Ground-Level Data, Ground-Level Photography, Remote Sensing Data, 3-D Models, Archive Records.
b. Non-Geographical Data: Public Records, Court Filings, News Articles, Legal Codes, Emails, Text Logs, Numerical Sequences, Genealogical Records, Academic Publications, Birth Announcements, Death Announcements, Trademark Files, Secretary of State Filings, SEC Filings, Communication Records, Chat Transcripts, Historical Data, Crowdsourced Data, Public Domain Information, Archive Records, All Public Data.
c. Proprietary Data: The Quav Code Key, Quav Code Mathematical Date Key, Quav Code Mathematical Decodation Formula, Copyrighted Observational Notes, Transcripts.
d. All Coding Techniques: Encompasses all known coding languages and technologies, including but not limited to HTML, CSS, JavaScript, JSON, XML, YAML, Regex, Python, PHP, Ruby, Node.js, Rust, DOS, UPC labeling, GTIN coding language, and cryptographic algorithms (SHA, MD5, Blockchain Data).

### 3. Decoding Framework

The decoding framework analyzes inputs to detect acronymical, numerical, and coding patterns. It combines diverse data types to identify correlations across geographical, non-geographical, and coding contexts.

### 4. Interpretation Engine

The interpretation engine contextualizes detected patterns to generate actionable insights. It processes user queries and provides tailored responses based on coding anomalies, repetition, and naming conventions.

### 5. Bot Assistance

The system includes a bot that assists in dataset curation, refinement, and interpretation. The bot enables efficient user interaction and enhances the system's usability.

### 6. Output

The system delivers outputs for various applications, including creative works, advocacy, coding pattern analysis, and analytical research.

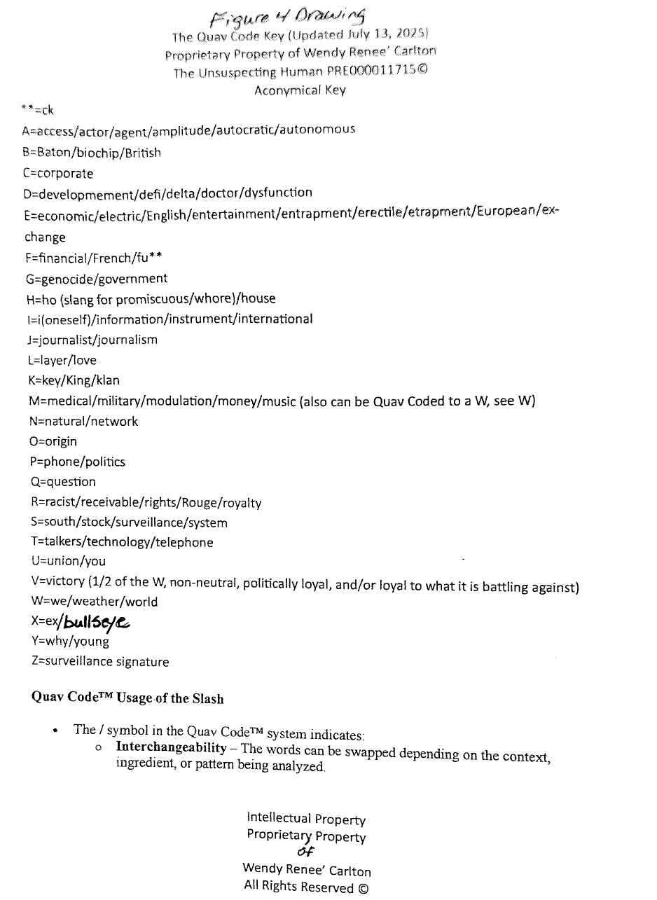

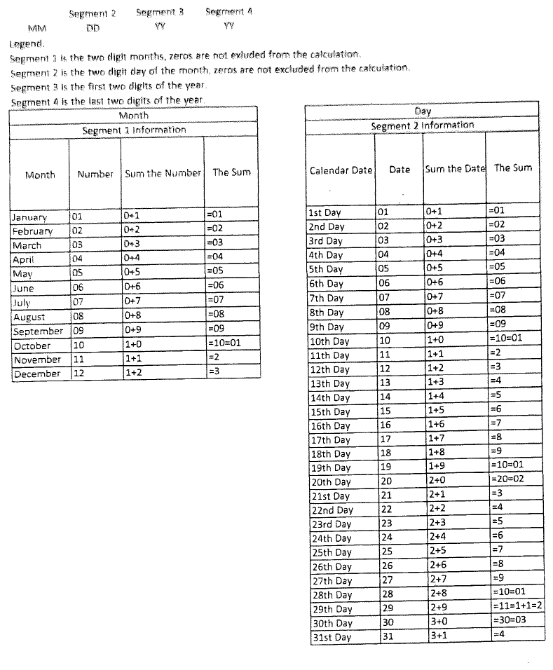

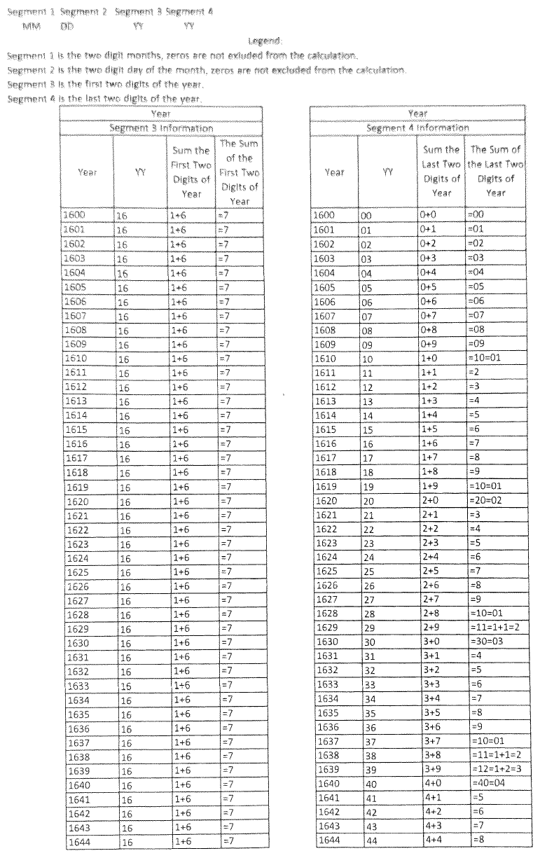

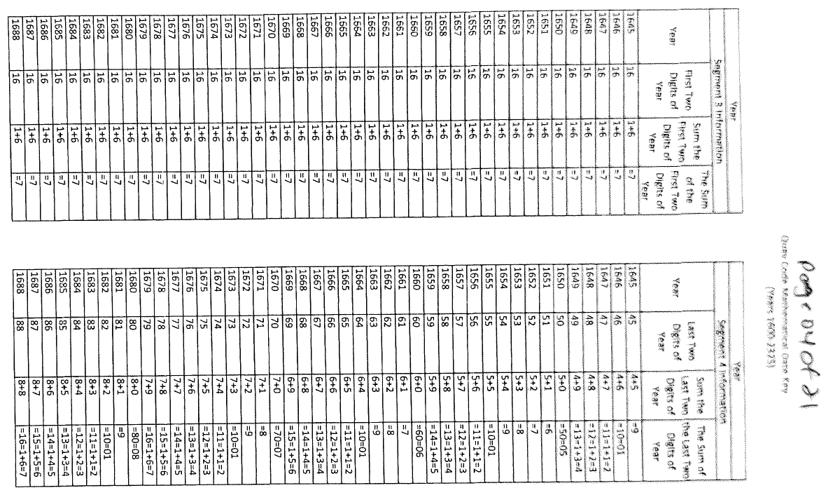

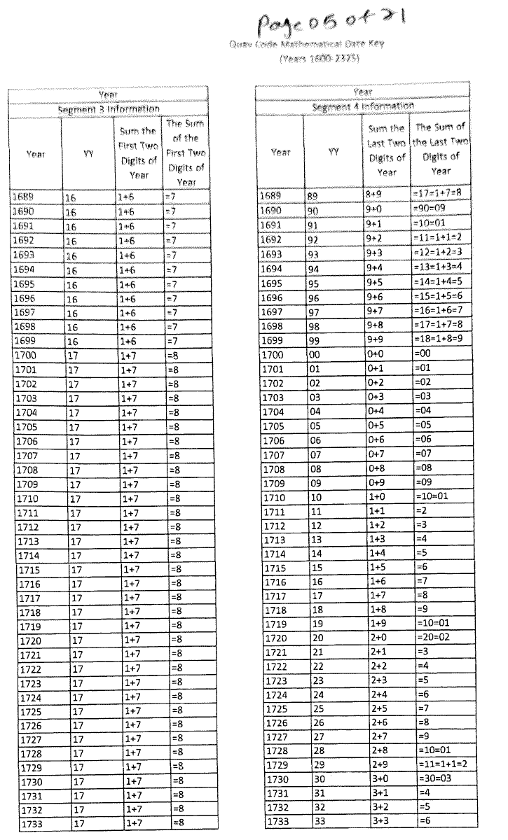

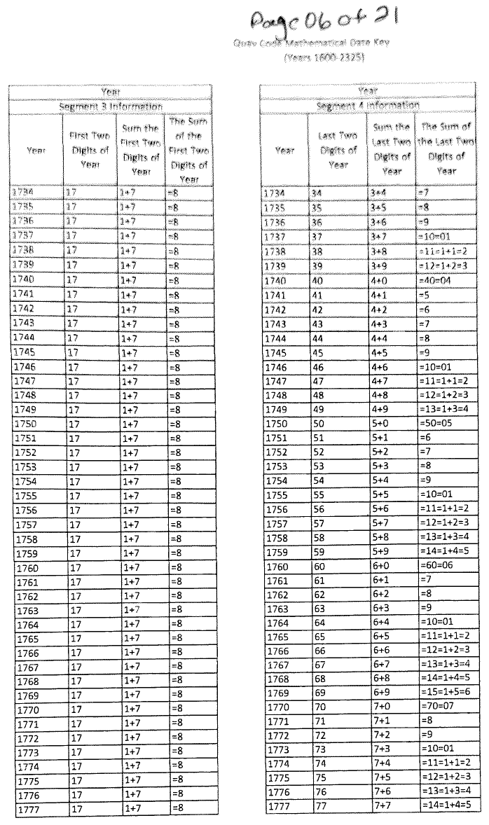

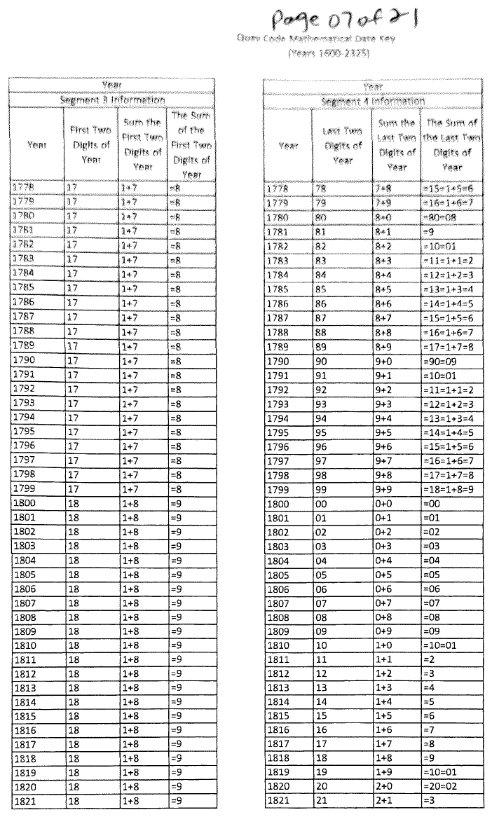

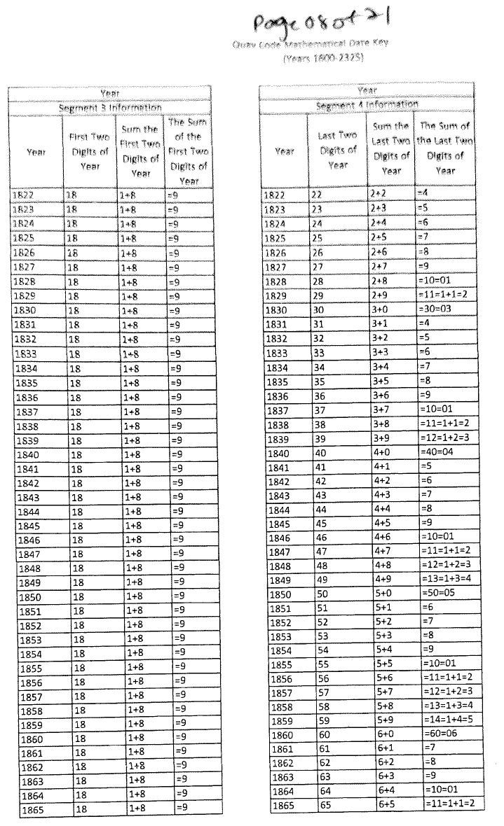

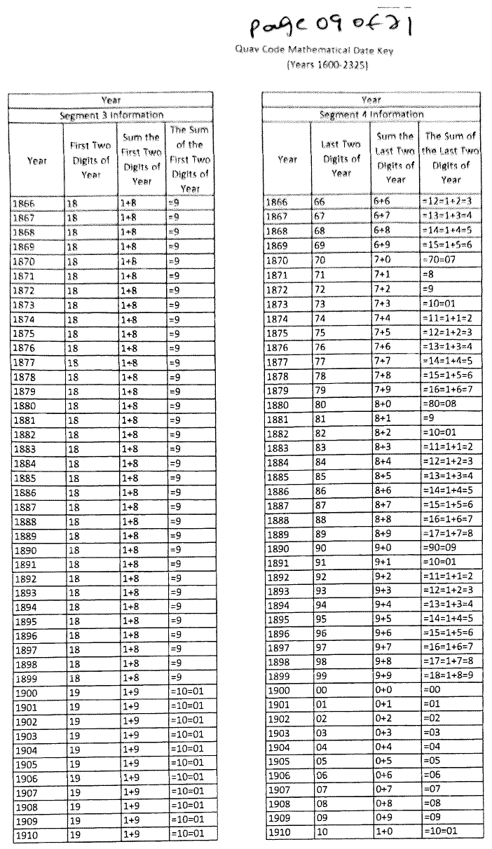

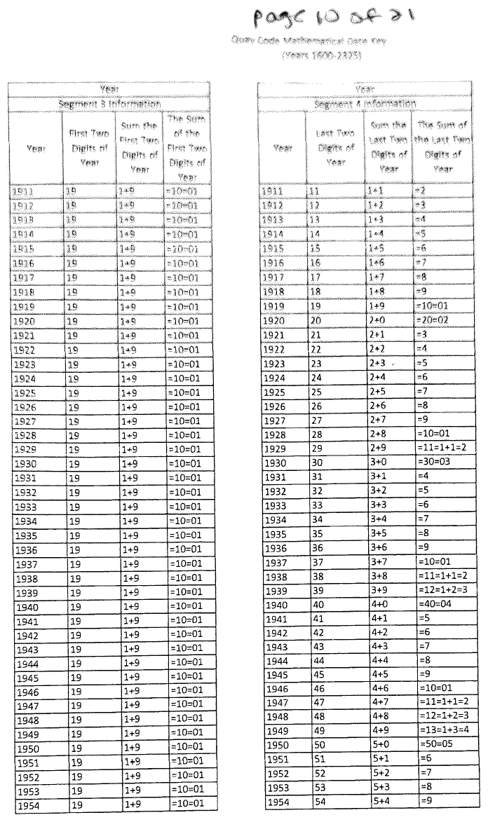

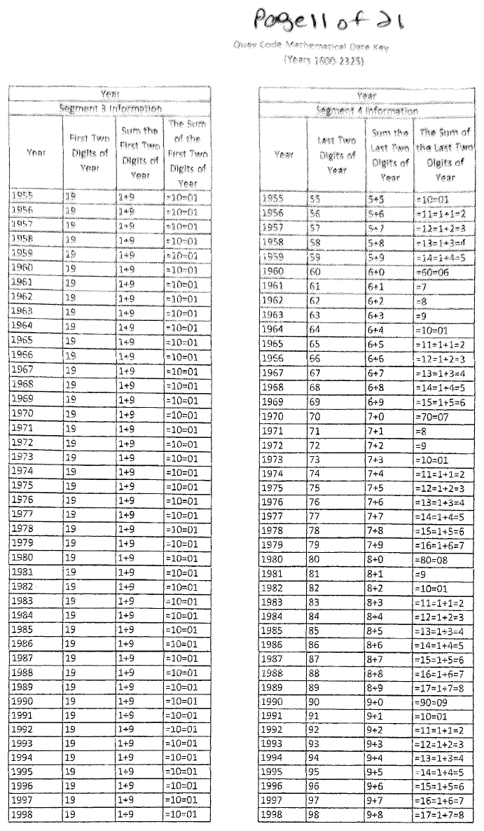

FIG. 1: Categorized Inputs is a diagram that organizes the types of information to be ingested by the Quav Code System named Candelyn the Brain. The inputs are divided into four categories: Geographical Data, Non-Geographical Data, Proprietary Data, and All Coding Techniques.

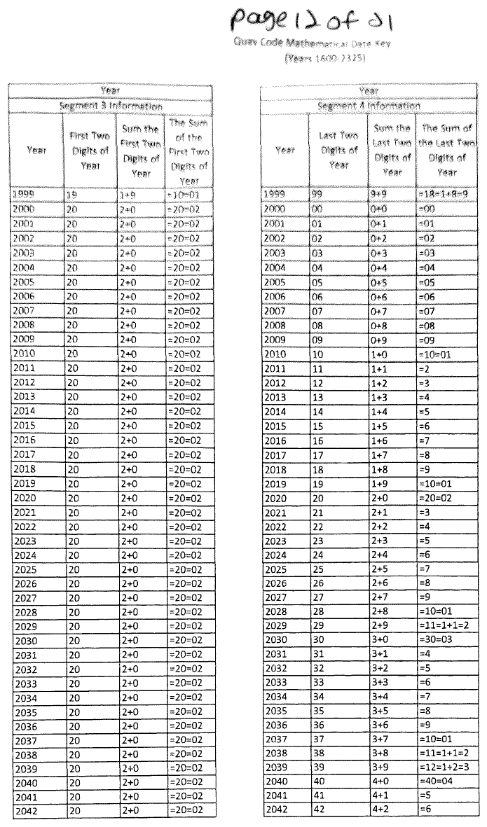

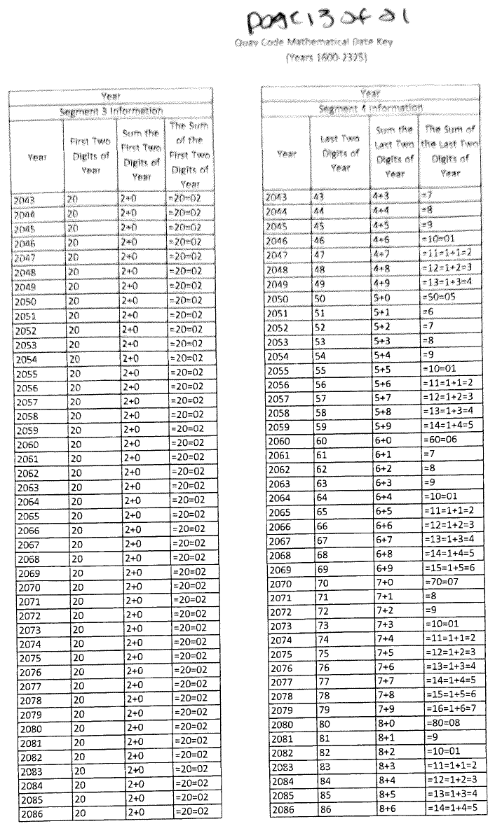

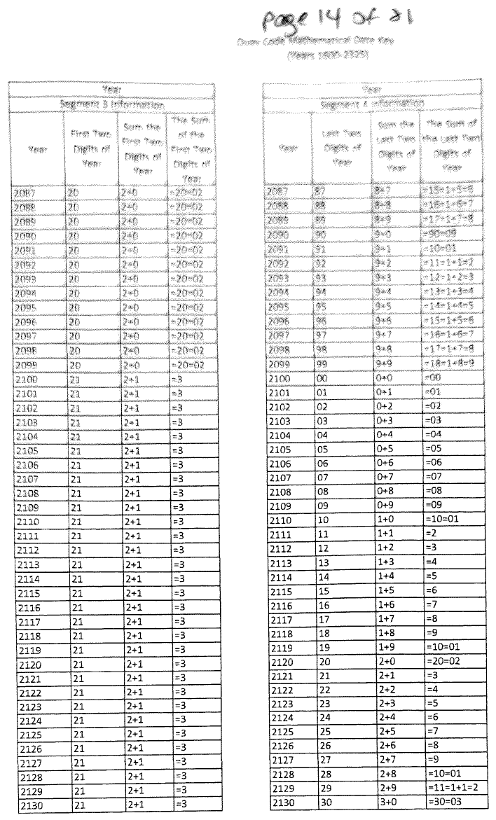

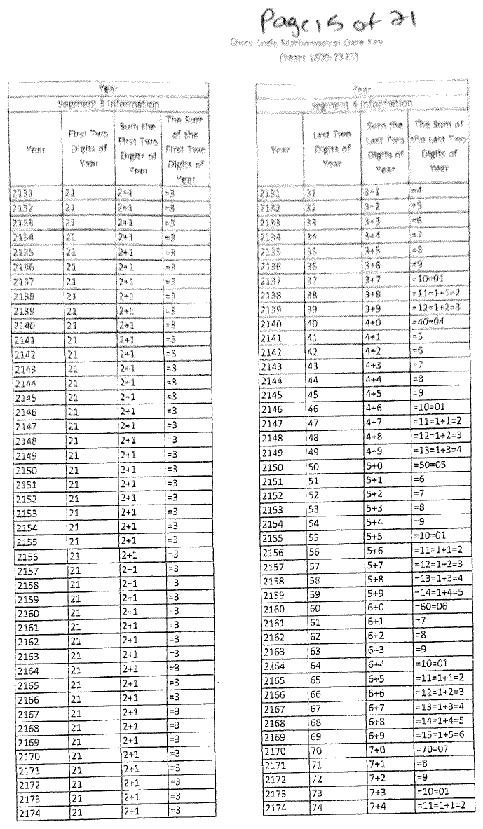

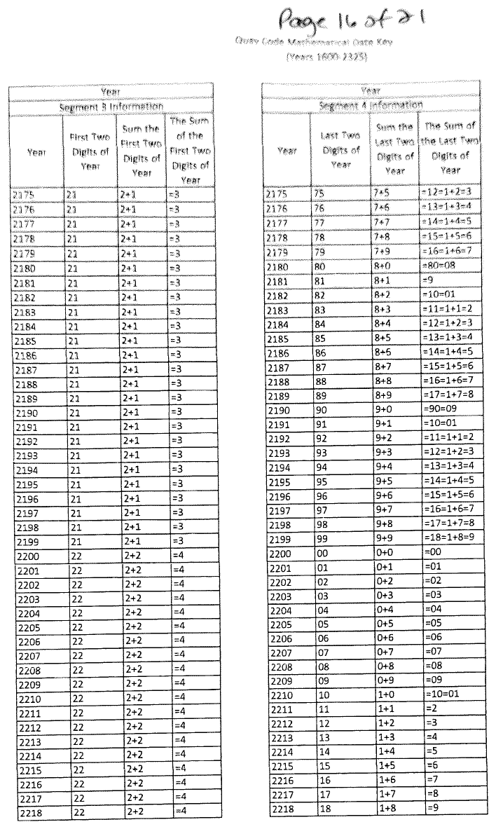

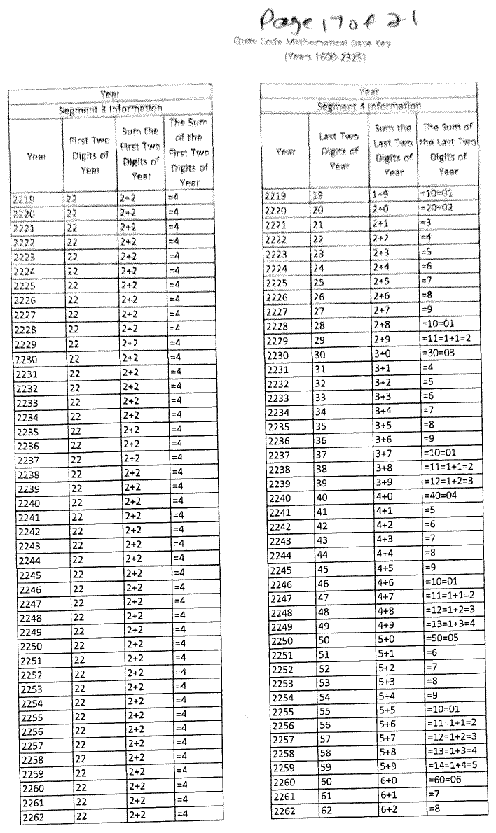

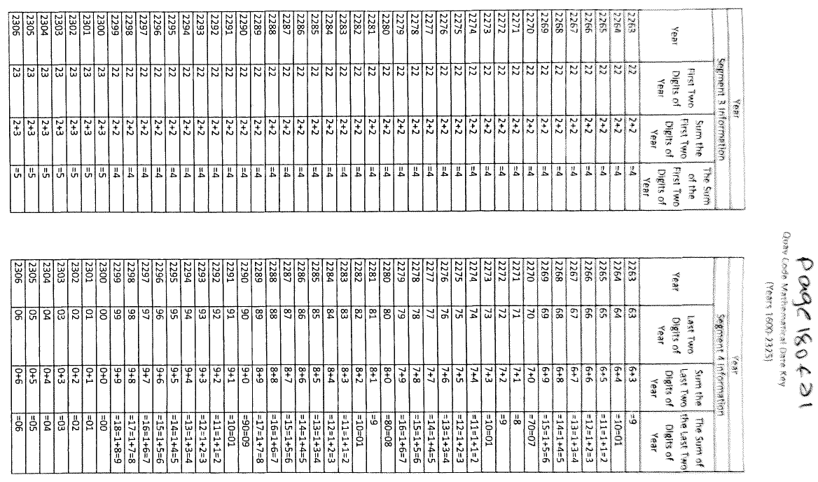

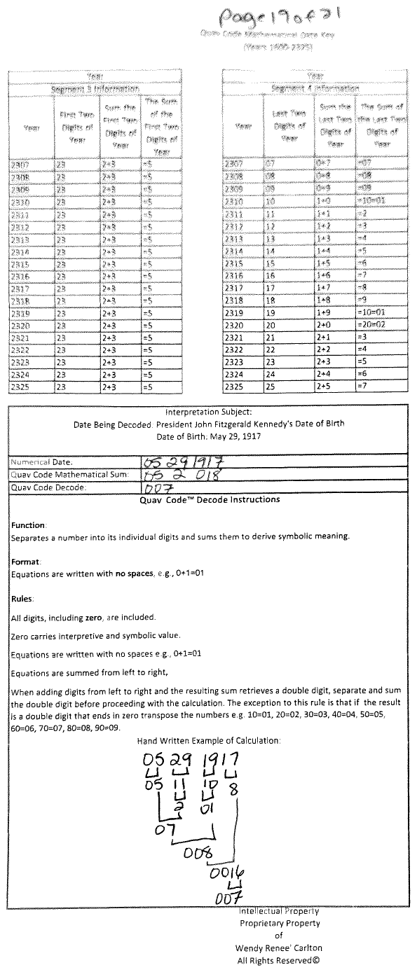

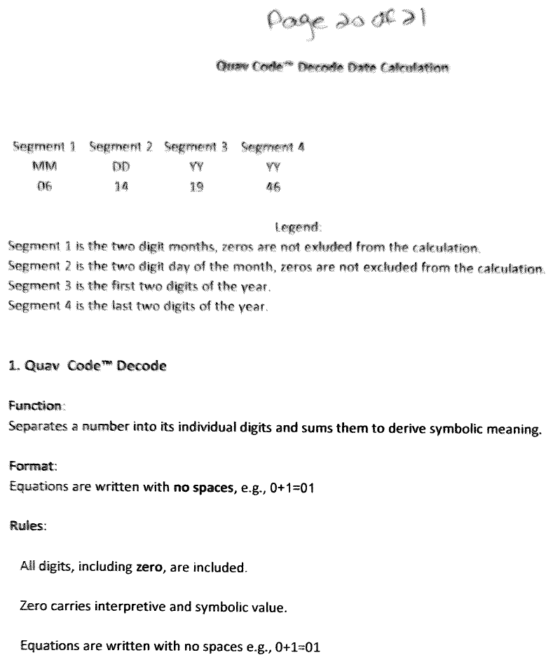

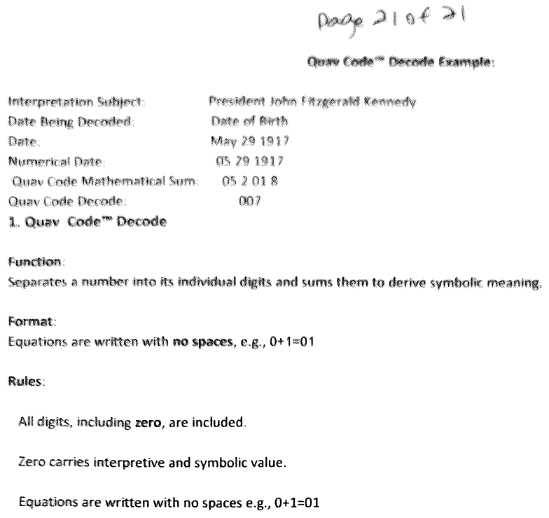

FIG. 2: The Workflow Diagram is a visual representation of the process that begins with the Input Collection (Step 1), followed by analysis within a Knowledge Base Decoding Framework (Step 2), and then contextualization through an Interpretation Engine (Step 3). This process enables decodations and interpretations to be generated, which are then made available for a Bot to assist the user via an interview-style output process.

### Inventor's Declaration of Autonomy and Non-Consent to Unauthorized Collaboration

The undersigned Inventor affirms that this patent application is filed autonomously and independently. I do not consent to any virtual, technological, biometric, or cognitive collaboration with unauthorized surveillance actors, entities, or individuals who may be engaging in observation, data manipulation, or unauthorized interpretation of this invention.

I explicitly reject the notion that I am a participant—willing or otherwise—in any virtual workspace, covert collaboration, or bio-cognitive partnership with surveillance-based operators, artificial intelligence handlers, or third-party data harvesters. This invention and all associated intellectual property originate from the undersigned alone, based on original thought, protected observational records, and independent authorship.

Any real-time or retroactive behavioral mimicry, unauthorized interpretation, or attempted co-authorship by surveillance-affiliated individuals or systems is hereby declared void and unconsented. This patent is a declaration of independent innovation, filed in good faith and in protection of sovereign creative rights.

1. A system for detecting and interpreting acronymical, numerical, and coding patterns, comprising:
a. a decoding framework for analyzing input data from geographical, non-geographical, proprietary, all coding sources, UPC labeling, and GTIN coding language.
b. an interpretation engine for contextualizing detected patterns into actionable insights.

2. The system of claim 1, wherein geographical data includes GIS datasets and satellite imagery.

3. The system of claim 1, wherein coding techniques include all known coding languages and technologies, such as HTML, CSS, JavaScript, JSON, XML, YAML, Regex, Python, PHP, Ruby, Node.js, Rust, DOS, UPC labeling, and GTIN coding language.

4. The system of claim 1, wherein the decoding framework identifies coding anomalies such as repetitive structures, unused variables, and inconsistent naming conventions.

5. The system of claim 1, wherein non-geographical data includes public records, numerical sequences, and academic publications.

6. The system of claim 1, wherein the interpretation engine incorporates regex-based pattern analysis and contextualizes results for code optimization.

7. The system of claim 1, wherein inputs include proprietary data such as the Quav Code Key, Copyrighted Observational Notes, Transcripts, Quav Code Mathematical Date Key, Quav Code Mathematical Decodation Formula

8. The system of claim 1, wherein the interpretation engine provides outputs for creative works, coding analysis, and advocacy.

9. The system of claim 1, wherein user queries are analyzed to prioritize input data sources for pattern detection.
